(19) United States
(12) Patent Application Publication
(10) Pub. No.: US 2018/0053105 A1
(43) Pub. Date: Feb. 22, 2018

(54) Model Training for Multiple Data Spaces for Pattern Classification and Detection

(71) Applicant: PAYPAL, INC., San Jose, CA (US)

(72) Inventors: Saurabh Paul, San Jose, CA (US); Rajesh Munavalli, San Jose, CA (US)

(21) Appl. No.: 15/240,614

(22) Filed: Aug. 18, 2016

(51) Int. Cl. G06N 5/04; G06N 99/00

(52) U.S. Cl. CPC G06N 5/047; G06N 99/005

(57) ABSTRACT

Various systems, mediums, and methods to process requests involve retrieving a first pattern detection model that is configured to detect a plurality of first patterns based on features of the first patterns. Processing the requests also includes retrieving a plurality of second patterns and selecting a plurality of second features for detecting the plurality of second patterns. Processing the requests further includes generating a second pattern detection model by incorporating one or more of the second feature into the first pattern detection model to create an interim pattern detection model and to train the interim model by second patterns. Then a request having a request pattern is received and based on the second detection model a pattern detection score is generated for the received request. The request is processed based on the detection score. In some embodiments, the user activity patterns are associated with the requests.

### BACKGROUND

Embodiments disclosed herein are related to systems and methods for detecting and classifying patterns associated with requests.

A system of processing requests may provide different processing options. The processing options can depend on one or more patterns that are incorporated into or associated with the request. The system of processing requests may detect the patterns incorporated into or associated with the requests and process the request based on the detection.

Additionally, the system of processing requests may need to detect the patterns, classify the detected patterns, and then select the processing option based on the classification of the patterns. Detection and classification of the patterns require a training of the system with known patterns. The training of the system of processing requests with known patterns can cause the system to detect and classify the known patterns with an acceptable accuracy. However, the pattern detection systems perform poorly when they encounter new, e.g., unknown, patterns.

There is therefore a need for a device, system, and method for updating the pattern detection systems and incorporating new patterns into the pattern detection systems.

### BRIEF DESCRIPTION OF THE FIGURES

FIG. 1 is a block diagram of an exemplary system for detecting request patterns, according to some embodiments.

FIG. 2 is a block diagram of an exemplary system for detecting request patterns, according to some embodiments.

FIG. 3 is a block diagram of an exemplary networked system of processing requests based on request patterns, according to some embodiments.

FIG. 4 is a block diagram of an exemplary system having modules for updating features, according to some embodiments.

FIG. 5 is a block diagram of an exemplary system for incrementally updating the pattern detection model, according to some embodiments.

FIG. 6 illustrates an exemplary method of updating a pattern detection model, according to some embodiments.

FIG. 7 illustrates an exemplary method of processing requests based on request patterns, according to some embodiments.

FIG. 8 is a block diagram of an exemplary network system, according to some embodiments.

Embodiments of the present disclosure and their advantages may be understood by referring to the detailed description provided herein. It should be appreciated that reference numerals may be used to illustrate various elements and/or features provided in the figures. Further, the figures may illustrate various examples for purposes of illustration and explanation related to the embodiments of the present disclosure and not for purposes of any limitation.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

In some embodiments, a system receives and processes requests. The received requests are processed based on patterns incorporated into or associated with the requests to determine a classification for the request and/or to recognize how the request should be processed. In some examples, the request includes data related to how the request is generated, who generated the request, when/where the request is generated, which resources/devices the request has accessed, etc. This data can be a historic log that includes actions performed or resources accessed and may be viewed as a pattern, e.g., pattern of actions associated with the request that can be incorporated into the request. In summary, the patterns associated with the requests can correspond to how the request is generated including the performed steps/actions leading to the generation of the request. In some examples, the pattern of how a request is generated is an indication that the request is authentic. Also, the patterns can include data related to where or when the request is generated or on which device the request is generated or transmitted from. Alternatively, an artificial pattern can intentionally be added to the request. In some examples, a secure pattern, such as a drawing, e.g., a facial image/drawing, can be added to the request. Example embodiments herein describe related technologies to generate accurate pattern detection scores that can accurately classify the request based on the request pattern and consequently process the request based on the classification. In some examples, based on the performed steps/actions leading to the generation of the request, the request can be classified into two groups of authentic requests and inauthentic, e.g., forged or fake requests such that an authentic request is processed by the system and a fake request is ignored by the system.

Consistent with some embodiments, there is provided a system having a non-transitory memory for storing at least a first and a second database. The system includes one or more hardware processors that are configured to execute instructions. The instructions when executed as one or modules by the one or more hardware processors may cause the system to perform operations described herein.

In some embodiments, the system retrieves a first pattern detection model from the first data base. The first pattern detection model may detect a number of first patterns that may be associated with a request. Also, the first pattern detection model may include a number of first features such that the first features are used for detecting the first patterns. In some examples, features are attributes of patterns and the patterns are recognized, e.g., detected based on the features.

In some examples, the patterns are the data related to user activities related to a system like the generation of financial transaction requests, e.g., payment requests, by the user and the features are one or more of the 1) merchant address, 2) the device the request was originated on, 3) address of the requester, and 4) the IP address the request was first transmitted from, etc. The features may be used for recognizing the pattern of providing the request and then authenticating the request based on the recognition.

In some other examples, the patterns might be alphabetic characters incorporated into the request, and the feature is one or more of the 1) area enclosing the character, 2) number of sharp edges of the character, and 3) drawing length of the character. The feature may be used for recognizing the incorporated characters and then authenticating the request based on the recognition.

In some embodiments, a number of second patterns are retrieved from a second database. In some examples, the first database and the second database are combined into a single database. In some examples, the first patterns are generated in a first time span and the second patterns are generated in a second time span distinct from the first time span and may optionally correspond to a time span later than the first time span. In some examples, the first and second time spans have temporal overlap.

In some embodiments, a number of second features are selected based at least on the second patterns and the second features may be used for detecting the second patterns. In some examples, the features are some parameters corresponding to the patterns and the patterns are detected based on the features. In some examples, a feature is selected such that when a pattern exists the feature has a first range of values, and when the pattern does not exist the feature has a second range of value distinct from the first range of value such that the value of the feature may be an indication of the presence or non-presence of the pattern.

In some embodiments, a second pattern detection model is generated based on the first pattern detection model. The generation of the second pattern detection model includes two steps. First, one or more of the second features are incorporated into the first pattern detection model to create a partially trained interim pattern detection model such that the partially trained interim pattern detection model includes features that do not exist in the first pattern detection model. Second, after adding the one or more second features, the partially trained interim pattern detection model is trained, e.g., re-trained using the second patterns. In some examples, the interim pattern detection model is a small modification, e.g., small perturbation, of the original first pattern detection model and thus still holds part of the training information of the first pattern detection model and thus may be called as partially trained interim pattern detection model.

In some embodiments, a request is received by the system, where the request may include a request pattern. In some examples, the second pattern detection model that is trained by the second patterns is applied by a pattern processing engine executed on the one or more processers of the system. In some examples, the second pattern detection model is applied to the request pattern and a pattern detection score for the request pattern is generated.

In some embodiments, the request is processed based on the pattern detection score. In some examples, two or more processing options are provided based on the pattern detection score. In some examples, the options may include ignoring, e.g., denying, the request.

In various circumstances, the example embodiments described herein may resolve various challenges with regards to processing the received requests by the system. The processing is based on request patterns associated with the request. The requests can be received through a network. The request pattern may be the steps performed through the network and by the network including accessing network resources. As such, the example embodiments described herein may resolve problems that did not exist before the availability of the computer networks, particularly generating detection scores related to requests and processing requests based on the pattern detection scores. Notably, the modules may be implemented with hardware, software, or possibly with aspects of both hardware and software.

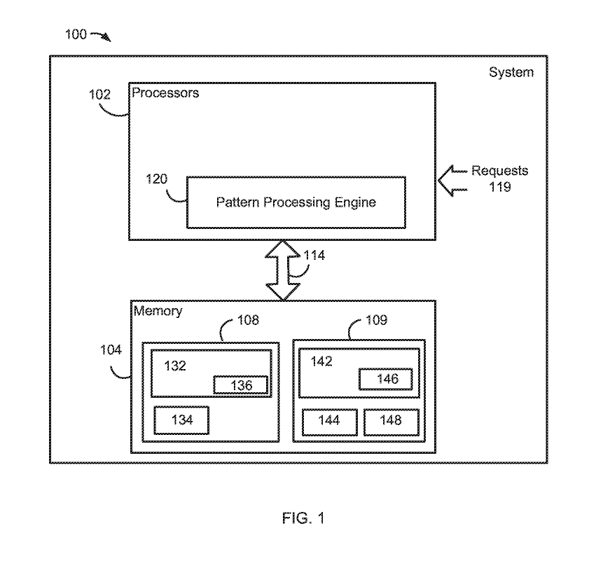

FIG. 1 is a simplified block diagram of an exemplary system 100 for detecting request patterns, according to some embodiments. The system 100 may also be used for processing requests 119. As shown, the system 100 includes one or more processors 102 and memory 104 consistent with a non-transitory memory. The memory 104 includes at least two databases, a first database 108 and a second database 109. The one or more processors 102 are coupled to memory 104 through connection, e.g., bus 114, and may access the memory 104. In some examples, the one or more processors 102 may execute a pattern processing engine 120. In some examples, the pattern processing engine 120 is stored in the memory 104 and includes the instructions that cause the system to perform the operations. In some other examples, the pattern processing engine 120 is included in the instructions, e.g., as part of the instructions that are stored in the memory 104. In some examples, the system 100 includes two or more memories including two or more non-transitory memories such that the instructions and the databases are stored in separate memories.

In some examples, the pattern processing engine 120 may be implemented using hardware components, such as a processor, an application specific integrated circuit (ASIC), a programmable system-on-chip (SOC), a field-programmable gate array (FPGA), and/or programmable logic devices (PLDs), among other possibilities.

In some embodiments, one or more patterns are associated with the requests 119. Alternatively, one or more patterns are incorporated into the requests 119. In some examples, the one or more patterns of the request 119 are retrieved by the pattern processing engine 120 from the memory 104.

In some embodiments, a first pattern detection model 132 is retrieved from the database 108 of the memory 104. The first pattern detection model may detect a plurality of first patterns 134. In an example, the plurality of first patterns 134 are stored in the database 108 of the memory 104. The first pattern detection model 132 includes a plurality of first features 136 where the first features 136 are used by the first pattern detection model 132 for detecting the first patterns 134. In some examples, the pattern processing engine 120, executing on the one or more processors 102, applies the first pattern detection model 132 to detect the first patterns 134 based on the first features 136.

In some examples, a plurality of second patterns 144 are retrieved from database 109 of the memory 104. Based at least on the plurality of second patterns 144, a plurality of second features 148 may be selected where the second features 148 may be used for detecting the second patterns 144. In some examples, the pattern processing engine 120, executing on the one or more processors 102, applies a pattern detection model, possibly different from the first pattern detection model 132, to detect one or more of the second patterns 144 based on one or more of the second features 148.

In some embodiments, the second pattern detection model 142 is generated based on the first pattern detection model 132. In some examples, the second pattern detection model 142 is stored in database 109 of the memory 104. The generation of the second pattern detection model 142 includes the incorporation of one or more of the plurality of second features 148 into the first pattern detection model 132 to create an interim pattern detection model. Incorporating one or more of the plurality of second features 148 to the first features 136 creates the updated features 146. In some examples, the second pattern detection model 142 uses the updated features 146, which include at least one or more features that are present in the features 136 of the first pattern detection model 132. The generation of the second pattern detection model 142 also includes training the second pattern detection model 142 using the plurality of second patterns 144. In some examples, the first patterns 134 are generated in a first time period and the second patterns 144 are generated in a second time period distinct from the first time period that may optionally correspond to a time period after the first time period. In some examples, the second time period may correspond to a time period after the first pattern detection model 132 is created. In some examples, the training of the second pattern detection model 142 is performed by pattern processing engine 120 executing on the one or more processors 102. The training may be performed iteratively and the iterations can continue until a predetermined level of accuracy in detecting the second patterns 144 is achieved.

In some embodiments, a request 119 is received by the system 100. The request 119 can include a request pattern. In some examples, the request pattern is associated with the request 119 and may include data related to the generation of the request 119. In some examples, the data may optionally include a location, time, and/or device used for generating the request. In some examples, for security purposes, a pattern such as a unique piece of data such as an image, or a sequence of numbers may be added as the request pattern to the request 119.

In some examples, the pattern processing engine 120 applies the second pattern detection model 142 to the request pattern of the request 119 to generate a pattern detection score for the request pattern of the request 119.

In some embodiments, the pattern processing engine 120 further processes the request 119. The processing is based on the generated pattern detection score. In some examples, the processing may include ignoring, e.g., denying the request. In some examples, the generated pattern detection score specifies the security level of the request 119 and the request 119 is only executed when it is deemed a secure request. In some examples, the pattern detection score can limit the extent to which the request 119 can be processed. In some examples, if the request is related to accessing a network system, a non-perfect pattern detection score can limit the extent of accessing the network. In some examples, if the request is related to accessing a financial system, a non-perfect pattern detection score can exert a limit, e.g., a limit on the amount the financial transactions.

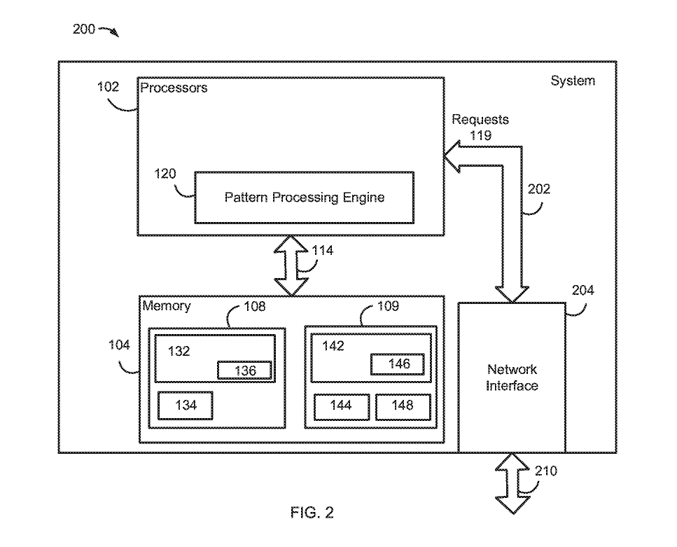

FIG. 2 is a simplified block diagram of an exemplary system 200 for detecting request patterns, according to some embodiments. The system 200 may also be used for processing requests 119. As shown and similar to FIG. 1, the system 200 includes one or more processors 102 and the memory 104 that are consistent with the processor 102 and memory 104 of system 100 of FIG. 1. Consistent with system 100, memory 104 includes at least two databases 108 and 109. The one or more processors 102 are coupled to memory 104 through connection, e.g., bus 114 and may access the memory 104. In some examples, the one or more processors 102 may execute a pattern processing engine 120. The system 200 also includes the network interface 204 that communicates between the one or more processors 102 and a network external to the system 200. The network interface 204 receives the requests 119 through the connection, e.g., network link 210 and then sends requests 119 through the connection, e.g., bus 202 to the one or processors 102.

In some embodiments, consistent with system 100 of FIG. 1, the system 200 includes the first pattern detection model 132, a plurality of first patterns 134, and the first features 136 that are used by the first pattern detection model 132 for detecting the first patterns 134. In some examples, the features 136 are attributes of the patterns 134 and are selected such that when an attribute exists a first range of values are assigned to the feature, and when the attribute does not exist, a second range of values distinct from the first range of values are assigned. In some examples, analyzing a pattern to find a feature and to assign a value associated with the pattern to the feature may be called “feature extraction”. In some examples, the value assigned to the feature indicates if an attribute exists in a pattern or does not exist.

In some embodiments, existence of a feature in a pattern may cause the recognition, e.g., detection of the pattern. In some examples, non-existence of a feature in a pattern may cause the recognition, e.g., detection of the pattern. In some examples, the existence of one or more first key features and non-existence of one or more second key features in a pattern may cause the recognition, e.g., detection of the pattern. In some examples, the pattern processing engine 120 may use the values assigned to the features and based on a predefined function calculate a pattern detection score and based on the calculated score the pattern processing engine 120 may detect the pattern, e.g., detects if the pattern exists or does not exist.

In some examples, the values assigned to the features are numbers, real or integer. In some examples, the values assigned to the features are logical values, e.g., yes/no, or true/false. In some examples, the values assigned to the features are fuzzy values, e.g., definitely exists, probably exists, probably does not exist, and definitely does not exist.

In some embodiments, consistent with system 100 of FIG. 1, the system 200 includes a second pattern detection model 142 that is generated based on the first pattern detection model 132. The generation of the second pattern detection model 142 includes the incorporation of one or more of the plurality of second features 148 into the first pattern detection model 132 to add to the first features 136 and create the updated features 146. In some examples, the second pattern detection model 142 comprises the updated features 146 that at least one of them does not exist in the features 136 of the first pattern detection model 132.

In some examples, the plurality of second patterns 144 are retrieved from the second database 109 of the memory 104. Based at least on the plurality of second patterns 144, a plurality of second features 148 may be selected where the second features 148 may be used for detecting the second patterns 144. In some examples, the pattern processing engine 120 applies a pattern detection model possibly different from the first pattern detection model 132 for detecting the second patterns 144 based on the second features 148. In some examples, the plurality of second patterns 144 include new patterns that did not exist and thus their features were not included when the first pattern detection model 132 was generated. In some examples, the plurality of second patterns 144, although are captured after the first pattern detection model 132 was generated may include one or more patterns similar to or the same as the first patterns 134.

In some examples, the number of features in the first pattern detection model 132 is between 200 and 800 features, e.g., 400 features. In some examples, the second pattern detection model 142 is created by incrementally updating the first pattern detection model 132 such that each time a predetermined and limited number of new features, e.g., 5 percent, 10 percent, and/or 15 percent is added to the already existing features to update the features of the pattern detection model. In some examples, the second pattern detection model 142 is created by incrementally updating the first pattern detection model 132, such as each time a predetermined and limited number of new features, e.g., 25, 50, and/or 100 features, is added to the already existing features to update the features of the pattern detection model. The generation of the second pattern detection model 142 also includes training the second pattern detection model 142 using the plurality of second patterns 144. In some examples, the first patterns 134 are generated in a first time period and the second patterns 144 are generated in a second time period distinct from the first time period that may optionally correspond to a time period after the first time period. In some examples, the second time period may correspond to a time period after the first pattern detection model 132 is created. In some examples, the training of the second pattern detection model 142 is performed by pattern processing engine 120 executing on the one or more processors 102. The training may be performed iteratively and the iterations can continue until a predetermined level of accuracy in detecting the patterns are achieved.

In some embodiments, one or more requests 119 is received through the network interface 204 and connection, e.g., network link 210 by the system 200. Each of the requests 119 can be associated with or may include a request pattern. In some examples, the request pattern is associated with the request 119 and may include data related the generation of the request 119. In some examples, the data may optionally include a location, time, and/or device used for generating the request. In some examples, for security purposes, a pattern such as a unique piece of data such as an image, a sequence of numbers, or a combination of an image and a sequence of numbers may be added as the pattern to the request 119.

In some examples, the pattern processing engine 120, executing on the one or more processors 102, implements the second pattern detection model 142 for detecting the request pattern of the request 119 received through the network interface 204 and to generate a pattern detection score for request pattern of the request 119.

In some embodiments, the pattern processing engine 120 processes the request 119 received through the network interface 204. The processing is based on the generated pattern detection score. In some example, the processing may include ignoring the request. In some examples, the generated pattern detection score specifies the security level of the request 119 received via the network interface 204 and the request 119 is only executed when it is deemed a secure request. In some examples, the pattern detection score can limit the extent of the request, e.g., the level the request can access resources or a limited time window for processing the request. In some examples, if the request is related to accessing a network system, a non-perfect pattern detection score can limit the extent of accessing the network, e.g., resources of the network. In some examples, if the request is related to accessing a financial system, a non-perfect pattern detection score can exert a limit on an amount of the financial transactions or can set a limited window of time the request can be processed.

As described, training the second pattern detection model 142 based on the first pattern detection model 132 may be done as an incremental training using the second patterns 144 such that the second patterns 144 used for the training did not exist at the time the first pattern detection model 132 was created. The training process in the incremental training is essentially faster than training using the whole data set of the first patterns 134 and second patterns 144. Specifically, the incremental training can occur in relatively short time spans, e.g., every month, every two months, and/or at any other suitable interval.

In some embodiments, in addition to selecting features, training second pattern detection model 142 includes defining structural rules or statistical rules of the patterns. The statistical rules include specifying a range of values for the features. The structural rules, besides specifying a range of values for the features, may optionally specify a logical value for the value and/or may include a grammar for how the features are positioned physically or temporally.

In some embodiments, the first pattern detection model 132 and the second pattern detection model 142 are models for detecting transaction fraud patterns. Also, the plurality of first patterns 134 and the plurality of second patterns 144 are transaction patterns that include fraud patterns. In some examples, the transaction requests include transaction patterns, and based at least on the detection score, the received transaction request is classified into a fraudulent transaction request group and the transaction request is not processed.

In some embodiments, the systems 100 and 200 of FIGS. 1 and 2, are systems that may receive a user request to allow the user to enter a gate, either physically by entering a secure door, or virtually by entering into a system such as a network. The user request may be validated by recognizing a pattern associated with the user request. In some examples, the pattern may include an image associated with the requester, e.g., a facial image, a fingerprint, an iris image, and/or the like.

In some embodiments, the plurality of first patterns and the plurality of second patterns are patterns of user activities interacting with a network-based system. In some examples, the first pattern detection model and the second pattern detection model are models for detecting patterns of activities of users when interacting with network-based systems. The plurality of first patterns and the plurality of second patterns are the patterns of activities of users when interacting with the network-based systems.

In some examples, the first pattern detection model and the second pattern detection model are models for detecting patterns of activities occurring inside a system. The plurality of first patterns and the plurality of second patterns are the patterns of activities associated with one or more subsystems of the system.

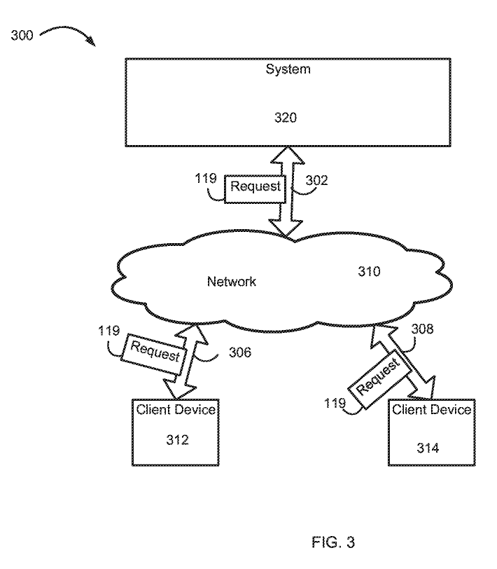

FIG. 3 is a block diagram 300 of an exemplary networked system of processing requests based on request patterns, according to some embodiments. The block diagram 300 includes a system 320 that is consistent with the system 200 of FIG. 2. The system 320 is connected through the connection, e.g., network link 302 to the network 310. The connection 302 is consistent with the connection 210 in FIG. 2 such that the system 320 can communicate through a network interface, e.g., network interface 204 with the network 310. the network 310 is LAN, WAN, wireless, Internet, and/or any network system.

In some embodiment, users can use client devices 312 and 314 to communicate through the network 310 to the system 320. The client devices 312 and 314 can send requests 119 through the connections, e.g., network links 306 and 308 to the network 310 and the network can send the requests 119 through the connection 302 to the system 320.

In some embodiments, the request 119 is received through a network interface consistent with network interface 204 of FIG. 2. The request 119 is received through the network 310 and from a client device 312 or 314 of a user. One or more features of one or more patterns associated with or incorporated into the received request 119 are extracted. The extracted features are consistent with the features 146 of FIGS. 1 and 2. A detection score corresponding to the received request 119 and based on the extracted features is generated. Consistent with the system 200 of FIG. 2, the detection score can be generated by the pattern processing engine 120 executing on the one or more processors 102 and applying the extracted features to a detection model that is consistent with the second pattern detection model 142 of FIGS. 1 and 2. The received request 119 is classified based on the detection score into one or more groups. The classification can be performed by the pattern processing engine 120 executing on the one or more processors 102. Then, the received request 119 is processed based on the detection score, classification, or both.

In some embodiments, the client device 312 or 314 is a mobile device communicating with the system 320 through the network 310, e.g., a wireless network or a cloud network.

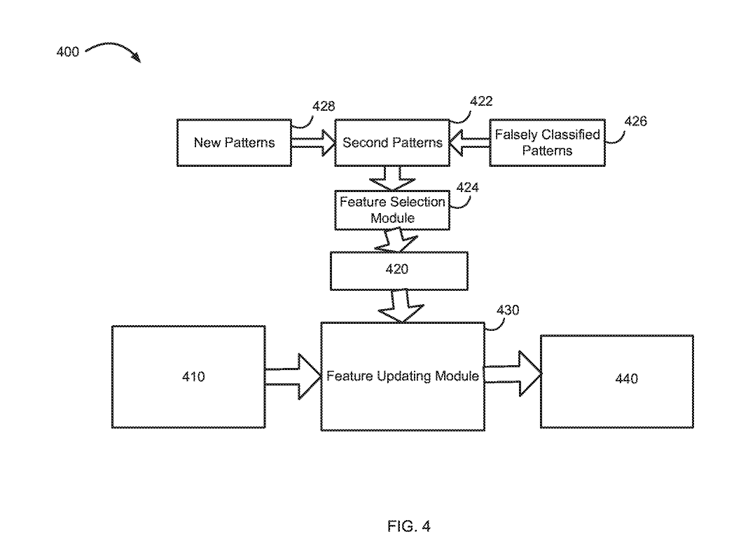

FIG. 4 is a block diagram 400 of an exemplary system having modules for updating the features, according to some embodiments. The block diagram 400 includes the existing features 410 that are consistent with the plurality of first features 136 of FIGS. 1 and 2. The block diagram 400 also includes the new features 420 that are consistent with the plurality of second features 148 of FIGS. 1 and 2. The block diagram 400 additionally includes the feature updating module 430 that receives the existing features 410 and new features 420 and combines one or more of the new features 420 into the existing features 410 and generates the updated features 440. The updated features 440 are consistent with the updated features 146 and the new features 420 are consistent with the second features 148 of FIGS. 1 and 2. In some examples, the feature updating module 430 is included in the pattern processing engine 120 of FIGS. 1 and 2.

In some embodiments, the existing features 410 that are consistent with feature 136 of the first pattern detection model 132 in FIGS. 1 and 2 are received from the first database 108 of the memory 104. In some examples, the new features 420 that are consistent with the plurality of second features 148 of FIGS. 1 and 2 and are generated by the feature selection module 424 that may be a module of the pattern processing engine 120 of FIGS. 1 and 2. The feature selection module 424 receives the second patterns 422 that are consistent with the second patterns 144 of FIGS. 1 and 2.

In some embodiments, the second patterns 422 include new patterns 428 that did not exist when the first pattern detection model 132 was generated and thus their features were not included when the first pattern detection model 132 was trained. In some examples, the second patterns 422, despite being captured after the first pattern detection model 132 was generated, may optionally include one or more falsely classified patterns 426. The falsely classified patterns are similar to or the same as the first patterns that are incorrectly recognized by the first pattern detection model 132, i.e., they are request patterns that are missed when they should have been recognized or are request patterns that are wrongly recognized by the first pattern detection model 132.

In some embodiments, when combining the existing features 410 and new features 420, some of the existing features 410 are removed such that the number of features in 410 and 440 are essentially equal and are within less than 5 percent, e.g., one percent, or other percentage of each other. As described, in the incremental training, the number of features selected from the new features 420 to be combined with the existing features 410 may be limited, e.g., to 10 percent of the number of features in 410. Also, in the incremental training, the updated pattern detection model is trained, e.g., re-trained with the second patterns 144 and thus the incremental training is a much faster process compared to generating a pattern detection model from scratch by training all features with all possible patterns.

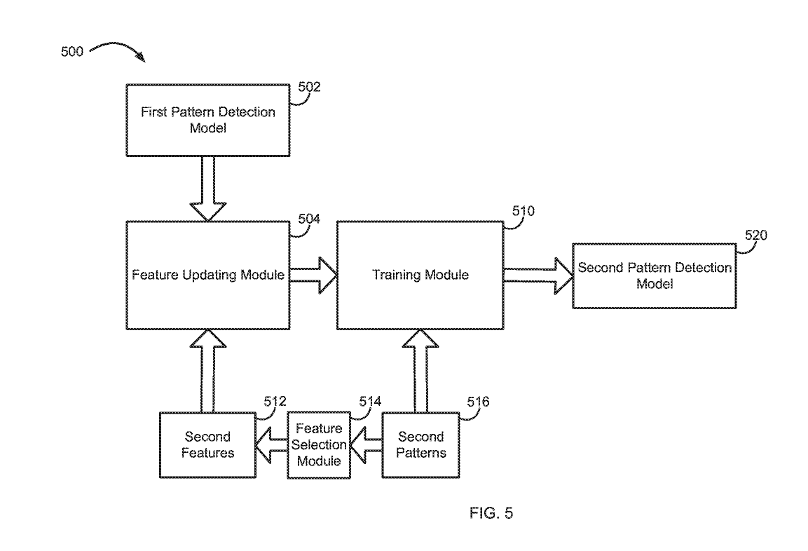

FIG. 5 is a block diagram 500 of an exemplary system having modules for incrementally updating the pattern detection model, according to some embodiments. In some examples, the second patterns 516 that are consistent with the second patterns 144 of the FIGS. 1 and 2 are captured after the first pattern detection model 502 is created. The first pattern detection model 502 is consistent with the first pattern detection model 132 of FIGS. 1 and 2. Additionally, the second patterns 516 are used by the feature selection module 514 to generate the second features 512 and the feature updating module 504 receives the first pattern detection model 502 as well as the second features 512 and incorporates one or more of the second features 512 into the features of the first pattern detection model 502. The second patterns 516 is consistent with the second patterns 422, the feature selection module 514 is consistent with the feature selection module 424, and the feature updating module 504 is consistent with feature updating module 430 of FIG. 4.

In some embodiments, the second pattern detection model 520 is consistent with the second pattern detection model 142 and the second features 512 are consistent with the second features 148 of FIGS. 1 and 2. Additionally, consistent with FIGS. 1 and 2, the feature updating module 504, the training module 510, and the feature selection module 514 may be modules of the pattern processing engine 120.

In some examples, the feature updating module 504 receives the first pattern detection model 502 and incorporates one or more of the second features 512 associated with the second patterns that are captured after the first pattern detection model 502 is created into the features of the first pattern detection model 502 to update the first pattern detection model 502. The training module 510 then receives the updated model and re-trains it using the second patterns 516 and creates the second pattern detection model 520.

In some examples, the re-training includes one or all of: updating pattern recognition rules, defining new pattern recognition rules, removing existing pattern recognition rules, updating pattern recognition parameters, removing existing pattern recognition parameters, and/or defining new pattern recognition parameters.

In some embodiments, the first pattern detection model 502 is directly fed into and training module 510 and the feature updating module 504 is skipped. In some examples, the second features 512 are not selected and the features of the first pattern detection model 502 are not updated. In some examples, the first pattern detection model 502 is re-trained by the second patterns 516 without first updating the first pattern detection model 502 such that the features of the first pattern detection model 502 are kept the same and the features of the second pattern detection model 520 and the model is merely re-trained by the new patterns, e.g., second patters 516. Thus, the second pattern detection model 520 has exactly the same features of the first pattern detection model 502.

In some examples, the training module 510 performs an iterative training of the updated model using the second patterns 516. In the iterative training, after applying one or more of the second patterns 516 to the updated model, based on the outcome of the updated model, the parameters of the updated model are further updated until a predefined level of accuracy in detecting the patterns is achieved. In some examples, the predefined level of accuracy includes correctly recognizing patterns having the desired attributes by a predefined percentage of accuracy, e.g., more than 90 percent and correctly rejecting patterns not having the desired attributes by a predefined percentage of accuracy, e.g., 98 percent. In some examples, the training includes modifying the pattern recognition rules and/or parameters such that in the patterns having the desired attributes are grouped with each other and patterns not having the desired attributes are also separately grouped with each other with a safe distance between the two groups. In some examples, the safe distance between the two groups is defined by the inaccuracy and noise that inherently exists in capturing the patterns. The distance between the two groups is safe and there is a low probability of inaccurate recognition when the distance is much larger than the inaccuracy of measurements and noise of data gathering associated with capturing the patterns.

In some embodiments, the first pattern detection model 502 and the second pattern detection model 520 are implemented as neural networks that include an input layer, a hidden layer, and an output layer. In some examples, the input layer of the neural network includes two or more nodes, where the number of nodes is equal to the number of features of the pattern detection model. In some examples, the input layer has between 200 and 800 nodes. In some examples, the neural network includes a hidden layer with between 10 and 20 nodes. In some examples, the output layer of a neural network may include a single node and the single node provides a pattern detection score.

In some embodiments, by adding one or more new nodes to the input layer of the neural network, one or more of the second features are incorporated into the neural network. In some examples, by removing one or more nodes of the input layer of the neural network, one or more of the existing first features are deleted from the neural network.

In some embodiments, the neural network is trained using the first patterns to generate the first pattern detection model 502. In some examples, possibly after adding one or more new input nodes and removing one or more existing input nodes, the neural network is re-trained using the second patterns to generate the second pattern detection model 520. In some examples, one or more methods including the simulated annealing or gradient descent are used for training the first pattern detection model 502 or for re-training second pattern detection model 520.

In some examples, the first pattern detection model 502 is generated using all patterns that were known and useful at the time of creation of the first pattern detection model 502. In some examples, the number of features in the first pattern detection model 502 is between 200 and 800 features. Thus, although the first pattern detection model 502 is stable, the creation of the first pattern detection model 502 may take a long time. In some other examples, updating the first pattern detection model 502 to create the second pattern detection model 520 is faster because the second pattern detection model 520 involves an incremental and limited change and a small and separate set of data, e.g., the second patterns 516, are used for its re-training. Keeping the changes between the first pattern detection model 502 and the second pattern detection model 520 to a limited, e.g., less than ten, percent of features may cause the second pattern detection model 520 to enjoy the stability of the first pattern detection model 502. In some examples, after a few, e.g., less than ten, incremental changes a pattern detection model using the complete set of patterns may be generated.

In some examples, the first patterns and the second patterns are financial transaction patterns that include fraudulent patterns. In some examples, the fraudulent patterns change at a much greater rate than a rate at which a pattern detection model using a full set of patterns can be created, tested, and implemented, and thus the incremental updating of the pattern detection model may be used to keep up with the rate that the fraudulent patterns change. Thus, the proposed incremental updating may solve a problem related to network or Internet based financial transactions in the area of security.

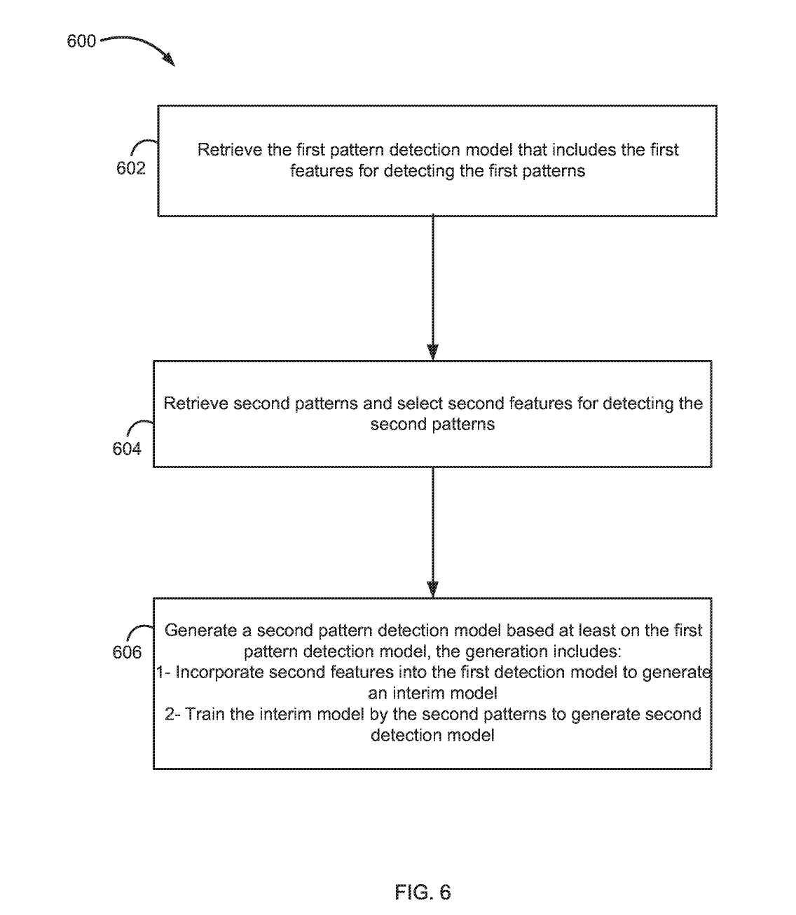

FIG. 6 illustrates an exemplary method 600 of updating a pattern detection model, according to some embodiments. Notably, one or more steps of the method 600 described herein may be omitted, performed in a different sequence, and/or combined with other methods for various types of applications contemplated herein. The method 600 may be performed by any of the systems 100, 200, and/or 320 of FIGS. 1-3. The method 600 can be used as a method of processing a request. In some embodiments, one or more the processes of the method 600 may be implemented by instructions (e.g., software instructions) stored on the non-transitory memory, e.g., non-transitory memory 104 of FIGS. 1 and 2 that is executed by one or more processors, e.g., the one or more processors 102 of FIGS. 1 and 2.

As shown in FIG. 6, at step 602, the method 600 may include retrieving the first pattern detection model. The first detection model may include the first features for detecting the first patterns and may optionally be retrieved from a first database, e.g., database 108 of FIGS. 1 and 2. In some examples, the first pattern detection model includes parameters and/or rules that are designed for distinguishing the first patterns 134 from each other. The first features are attributes of the first patterns and are selected such that the patterns including the attributes and the patterns not including the attribute are distinguishable from each other. In some examples, the features are selected such that the patterns including the attributes and the patterns not including the attributes are clustered and separate from each other in the space defined by the features. In some examples, the first patterns are normalized and redundant features are removed. In some examples, the removed features are related to patterns that belong to the past and do not occur anymore.

In some examples, the requests are financial transaction requests. In some examples, a specific version of an IOS or Android software may have a security bug. The software version may be selected as one of the features extracted from the request patterns of a financial transaction request. By recognizing that a financial transaction request is originated from a mobile device having the problematic software version, the system may impose a limit on the amount of the financial transaction request. Later on, when the software is updated and the security bug is removed, there may not be any need to have the software version as a feature and this feature may be retired, e.g., removed.

At step 604, the method 600 may include retrieving second patterns and selecting second features for detecting the second patterns. The second patterns 144 may optionally be retrieved from the second database, e.g., database 109 of FIGS. 1 and 2. The second features are attributes of the second patterns and are selected such that the patterns including the attributes and the patterns not including the attribute are distinguishable from each other. In some examples, the features are selected such that the patterns including the attributes and the patterns not including the attribute are clustered and separate from each other in the space defined by the features. In some examples, the second patterns 144 are normalized and redundant features are removed. In some examples, the second patterns 144 are produced after the first pattern detection model was generated.

At step 606, the method 600 may include generating a second pattern detection model based at least on the first pattern detection model. In some examples the first pattern detection model and the second pattern detection model are consistent with the pattern detection models 132 and 142 in FIGS. 1 and 2. The generation of the second pattern detection model may include the incorporation of the second features into the first pattern detection model to create an interim pattern detection mode. In some examples and consistent with FIGS. 1 and 2, one or more from the second features are incorporated into the first pattern detection model such that the first pattern detection model is updated by adding one or more features from the second features to the already existing features of the first pattern detection model. As noted, in some examples, the first pattern detection model is updated by adding one or more features from the second features and deleting one or more of the already existing features of the first pattern detection model. In some examples, the one or more deleted features, e.g., retired features, are associated with patterns that are not expected to occur. The generation of the second pattern detection model may also include training, e.g., re-training, the interim pattern detection model by the second patterns 144 to generate the second pattern detection model. The training can be performed by the pattern processing engine 120 executing on the one or more processors 102 of FIGS. 1 and 2.

In some examples, the first pattern detection model is generated by analyzing the complete set of patterns, e.g., the first patterns 134, and selecting a set of first features/attributes 136 from detecting the first patterns 134. In some examples, the feature selection may include designating the first patterns 134 into a number of groups of associated patterns and then selecting separate features for each group of associated patterns. In some examples, the feature selection may include normalizing the patterns associated with each other. In some embodiments, the first pattern detection model is trained with the complete set of first patterns 134. In some examples, another feature selection may be performed after the training that include analyzing all the features with respect to detecting all the patterns and reducing the feature space dimensions by 1) removing the features that are not effective in distinguishing the patterns and 2) removing the features that can distinguish rarely occurring patterns. In some embodiments, the second pattern detection model is generated using the second patterns 144. The second patterns 144 are the patterns that occurred after the first pattern detection model was created, and thus the second pattern detection model 142 is incrementally generated based on the first pattern detection model 132.

The processes of method 600 are now described in the context of a representative example related to how a pattern detection model for classifying a transaction request, e.g., a financial transaction request, is updated. In some examples, at step 602, a first pattern detection model for detecting request patterns of financial transaction requests is retrieved. The first pattern detection model can determine whether a financial transaction request is valid, e.g., legitimate. The validity is determined based on the request pattern associated with the financial transaction request and by applying the pattern detection model to the request pattern. In some examples, the request pattern is the information related to location, time, and/or steps of the request. In some examples, the request pattern includes the IP address and/or location of the device making the request, a credit card and/or account number associated with the request, the last time the account associated with the request was accessed, the number of accounts having access to the credit card, the individual making the request, and/or the like. At step 604, second request patterns are retrieved. The second request patterns are associated with financial transaction requests that have occurred after the first pattern detection model was generated. At step 606, the second pattern detection model is generated by updating the first pattern detection model such that features related to second request patterns are incorporated and to create an interim, e.g., updated, pattern detection model. The updated model is re-trained by the second request patterns associated with financial transaction requests that have occurred after the first pattern detection model was generated.

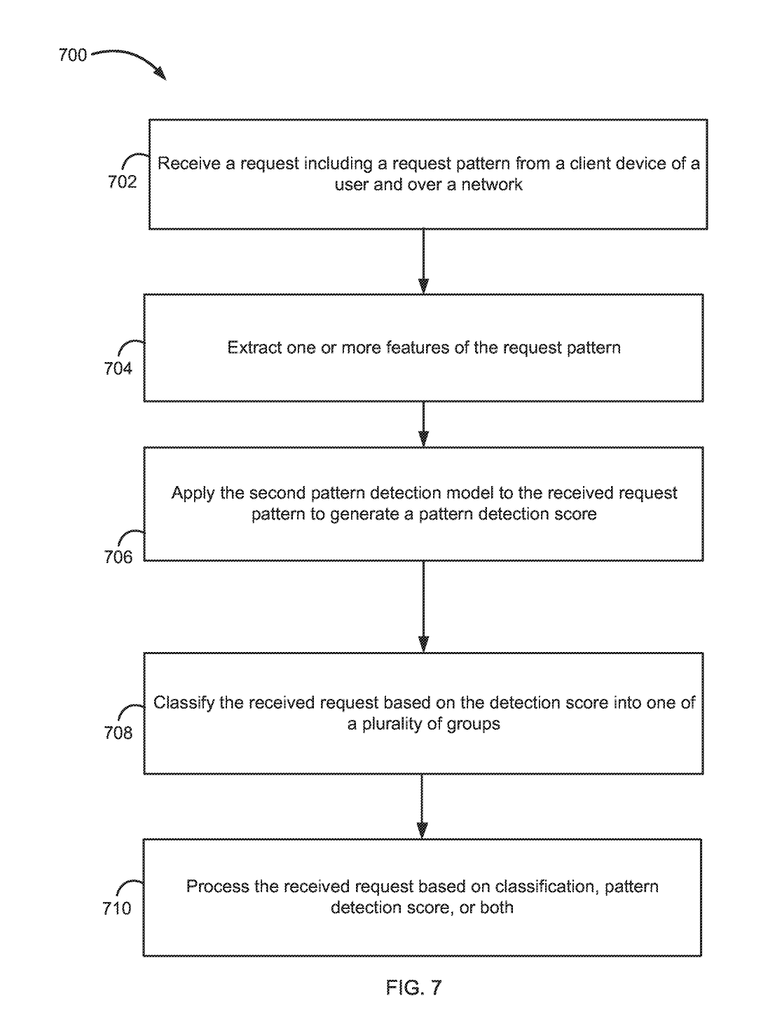

FIG. 7 illustrates an exemplary method 700 of processing requests based on request patterns, according to some embodiments. Notably, one or more steps of the method 700 described herein may be omitted, performed in a different sequence, and/or combined with other methods for various types of applications contemplated herein. The method 700 may be performed by any of the systems 100, 200, and/or 320 of FIGS. 1-3. The method 700 can be used as a method of processing a request. In some embodiments, one or more of the processes of the method 700, may be implemented by instructions (e.g., software instructions) stored on the non-transitory memory, e.g., non-transitory memory 104 of FIGS. 1 and 2, that is executed by one or more processors, e.g., the one or more processors 102 of FIGS. 1 and 2.

As shown in FIG. 7, at step 702, the method 700 may include receiving a request that includes a request pattern from a client device of a user. The request can be received over a network. Consistent with FIG. 3, the request 119 can be received from a client device 312 or 314 of a user over the network 310 and the received request may include a request pattern. In some examples, the request pattern is the actions performed by the user leading to the request. The request patterns are consistent with request patterns of FIG. 2.

At step 704, the method 700 may include extracting one or more features of the request pattern. In some examples, the features are already selected and the feature extraction assigns a value, e.g., a logical value, to the feature. In some examples, the request is a financial transaction request and the feature is the location of the user, e.g., requester. Feature extraction is finding the location of the user and assigning it to the feature.

At step 706, the method 700 may include applying the second pattern detection model to the request pattern to generate a pattern detection score. Thus, a pattern detection score is generated based on the application of the second pattern detection model for the received request. In some examples, the second pattern detection model 142 is applied to the request pattern of the received request to generate a pattern detection score. Consistent with FIGS. 1 and 2, the pattern processing engine 120 may apply the second pattern detection model on the request pattern of the request to generate the pattern detection score. Consistent with FIG. 2, the request 119 can be received through the network interface 204. In some examples, a request pattern is associated with/included in the request and is received by the pattern processing engine. The pattern processing engine then applies the second pattern detection model 142 to the request pattern of the request, and generates a pattern detection score. In some examples, the pattern detection score determines how legitimate the request is, such as by comparing the score with a threshold value.

At step 708, the method 700 may include classifying the received request based on the pattern detection score. The received request may be classified into one of a plurality of groups. Consistent with FIGS. 1 and 2, the pattern processing engine 120 may perform the classification. In some examples, the request is a financial transaction request and based on the pattern detection score the financial transaction request can be classified as one of: executing the request, executing the request after imposing a transaction limit, executing the request after imposing a time limit, and denying the request.

At step 710, the method 700 may include processing the request based on the pattern detection score, the classification, or both. As noted, in some examples, the pattern detection score indicates how legitimate the request is, and based on this determination the request is processed without limitation, the request gets extra limitations in time or amount, or the request is ignored, e.g., denied.

The processes of method 700 are now described in the context of a representative example related to determining how a transaction request, e.g., a financial transaction request, is processed. In some examples, at step 702, a financial transaction request and its associated request pattern is received from a client device of a user and over a network. At step 704, one or more features of the request pattern of the financial transaction request are extracted. At step 706, the second pattern detection model is applied to the request pattern of the received financial transaction request and a pattern detection score is generated. The pattern detection score is an indication of the validity of the financial transaction request. At step 708, the received financial transaction request is classified based on the detection score into one of a plurality of groups. At step 710, the financial transaction request is processed based on the pattern detection score, the classification, or both. If the pattern detection score indicates that it is a valid request, then the financial transaction request is executed, and if the pattern detection score indicates that it is a fraudulent financial transaction request, then it is denied.

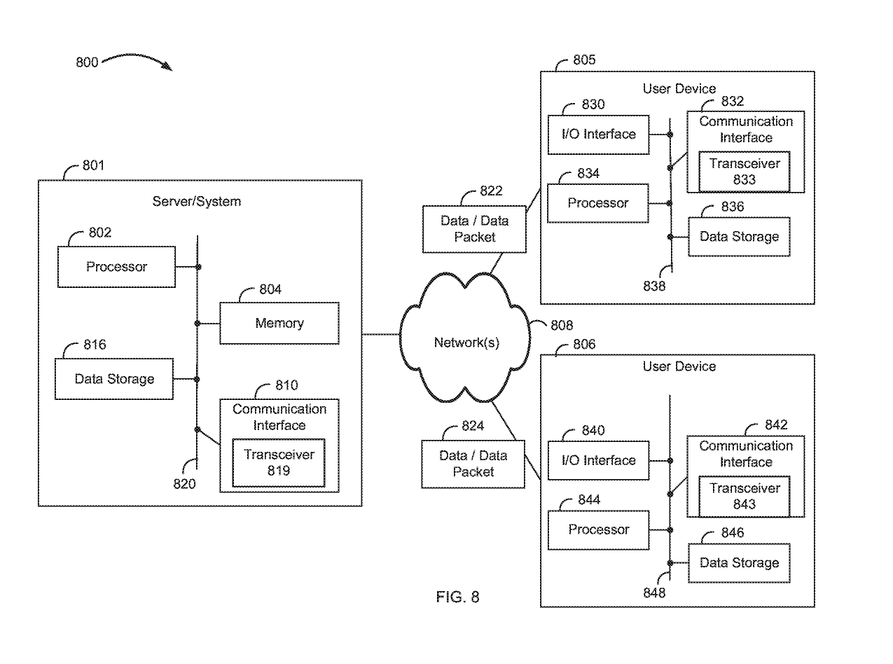

FIG. 8 is a block diagram of an exemplary network system 800, according to some embodiments. The network system 800, possibly referred to as the network system for processing requests, is consistent with the network 310 of FIG. 3 and may be configured to transfer data over one or more communication networks 808. The communication network 808 is consistent with network 310 of FIG. 3. In particular, the network system 800 may include the system/server 801. In some examples, system/server 801 may be consistent with system 200 of FIG. 2. The system/server 801 may be configured to perform operations of a service provider, such as PayPal, Inc. of San Jose, Calif., USA. Further, the network system 800 may also include a client device, e.g., a user device 805 and/or a client device, e.g., a user device 806 operated by their respective users. The user device 805 and/or the user device 806 are consistent with the client devices 312 and 314 of FIG. 3. In practice, the system/server 801 and the user devices 805 and/or 806 may be configured to communicate over the one or more communication networks 808.

In some embodiments, the network system 800 may include the server 801. The server 801 includes the non-transitory memory 804 that is consistent with the memory 104 of the FIGS. 1 and 2. The server 801 of the network system 800 has one or more hardware processors 802, consistent with the processors 102 of FIGS. 1 and 2, coupled to the non-transitory memory 804 and configured to read the instructions from the non-transitory memory 804 to cause the network system 800 to perform the operations as described further below.

The network system 800 may operate with more or less than the computing devices shown in FIG. 8, where each device may be configured to communicate over one or more communication networks 808, possibly to transfer data accordingly. The one or more communication networks 808 may also include a packet-switched network configured to provide digital networking communications, possibly to exchange data of various forms, content, type, and/or structure. The one or more communication networks 808 may include a data network such as a private network, a local area network, a wide area network, and/or the like. In some examples, the one or more communication networks 808 may include a communications network such as a telecommunications network and/or a cellular network with one or more base stations, among other possible networks.

The data/data packets 822 and/or 824 may be transferrable using communication protocols such as packet layer protocols, packet ensemble protocols, and/or network layer protocols. In some examples, the data/data packets 822 and/or 824 may be transferrable using transmission control protocols and/or internet protocols (TCP/IP). In various embodiments, each of the data/data packets 822 and 824 may be assembled or disassembled into larger or smaller packets of varying sizes. As such, data/data packets 822 and/or 824 may be transferrable over the one or more networks 808 and to various locations in the network system 800. In some examples, the data packets 822 and 824 are consistent with requests 119 of FIGS. 1 and 2.

In some embodiments, the server 801 may take a variety of forms. The server 801 may be an enterprise server, possibly configured with one or more operating systems to facilitate the scalability of the network system 800. In some examples, the server 801 may configured with a Unix-based operating system to integrate with a growing number of other servers, user devices 805 and/or 806, and one or more networks 808 over the network system 800.

In some embodiments, the system/server 801 may include multiple components, such as a hardware processor 802, a non-transitory memory 804, a non-transitory data storage 816, and/or a communication interface component 810, among other possible components, any of which may be communicatively linked via a system bus, network, or other connection mechanism 820. The hardware processor 802 may be implemented using a multi-purpose processor, a microprocessor, a special purpose processor, a digital signal processor (DSP) and/or other types of processing components. In some examples, the processor 802 may include an application specific integrated circuit (ASIC), a programmable system-on-chip (SOC), and/or a field-programmable gate array (FPGA) to process, read, and/or write data for providing services to numerous entities. In particular, the processor 802 may include a variable-bit (e.g., 64-bit) processor architecture specifically configured to facilitate the scalability of the increasing number of entities. As such, the one or more processors 802 may execute varying instructions sets (e.g., simplified and complex instructions sets) with fewer cycles per instruction than other conventional general-purpose processors to improve the performance of the server 801 for purposes of mass scalability and/or accommodation of growth.

The non-transitory memory component 804 and/or the data storage 816 may include one or more volatile, non-volatile, and/or replaceable data storage components, such as a magnetic, optical, and/or flash storage that may be integrated in whole or in part with the hardware processor 802. Further, the memory component 804 may include a number of instructions and/or instruction sets. The processor 802 may be coupled to the memory component 804 and configured to read the instructions to cause the server 801 to perform operations, such as those described in this disclosure, illustrated by the accompanying figures, and/or otherwise contemplated herein. Notably, the data storage 816 or memory 804 may be configured to store numerous user data, possibly including data that may be accessed often by the user devices 805 and/or 806. In some examples, the user data may include user ID and access codes or authentication tokens of a user.

The communication interface component 810 may take a variety of forms and may be configured to allow the server 801 to communicate with one or more devices, such as the user devices 805 and/or 806. The communication interface component 810 is consistent with the network interface 204 of FIG. 2. In some examples, the communication interface component 810 may include a transceiver 819 that enables the server 801 to communicate with the user devices 805 and/or 806 via the one or more communication networks 808. Further, the communication interface component 810 may include a wired interface, such as an Ethernet interface, to communicate with the user devices 805 and/or 806. Yet further, the communication interface component 810 may include a wireless interface, such as a cellular interface, a Global System for Mobile Communications (GSM) interface, a Code Division Multiple Access (CDMA) interface, and/or a Time Division Multiple Access (TDMA) interface, among other possibilities. In addition, the communication interface 810 may include a wireless local area network interface such as a WI-FI interface configured to communicate with a number of different protocols. As such, the communication interface 810 may include a wireless interface configured to transfer data over short distances utilizing short-wavelength radio waves in approximately the 2.4 to 2.485 GHz range. In some instances, the communication interface 810 may send/receive data or data packets 822 and/or 824 to/from user devices 805 and/or 806.

The user devices 805 and 806 may also be configured to perform a variety of operations such as those described in this disclosure, illustrated by the accompanying figures, and/or otherwise contemplated herein. Notably, the data storage 836/846 of the user devices 805 and 806 may be configured to store numerous user data, possibly including data that may be accessed often by the user devices 805 and 806 such as geographic/address data, request data, pattern data including action patterns, movement data including movement patterns, exercise data including exercise patterns, among other types of data associated with the user. In some examples, the user devices 805 and 806 may be configured to authenticate a user of the user devices 805 and 806 based on data stored, e.g., a security token, e.g., a PIN or password, in the user devices. Alternatively, the server 801 may authenticate a user based on receiving the security token from the user devices 805 and 806.

In some embodiments, the user devices 805 and 806 may include or be implemented as a user device system, a personal computer (PC) such as a laptop device, a tablet computer device, a wearable computer device, a head-mountable display (HMD) device, a smart watch device, and/or other types of computing devices configured to transfer data. The user devices 805 and 806 may include various components, including, for example, input/output (I/O) interfaces 830 and 840, communication interfaces 832 and 842 that may include transceivers 833 and 843, hardware processors 834 and 844, and non-transitory data storages 836 and 846, respectively, all of which may be communicatively linked with each other via a system bus, network, or other connection mechanisms 838 and 848, respectively.

The I/O interfaces 830 and 840 may be configured to receive inputs from and provide outputs to respective users of the user devices 805 and 806. In some examples, the I/O interfaces 830 and 840 may include a display that provides a graphical user interface (GUI) configured to receive an input from a user. Thus, the I/O interfaces 830 and 840 may include displays configured to receive inputs and/or other input hardware with tangible surfaces, such as touchscreens with touch sensitive sensors and/or proximity sensors. The I/O interfaces 830 and 840 may also include a microphone configured to receive voice commands, a computer mouse, a keyboard, and/or other hardware to facilitate input mechanisms, possibly to authenticate a user. In addition, I/O interfaces 830 and 840 may include output hardware such as one or more sound speakers, other audio output mechanisms, haptic feedback systems, and/or other hardware components.

In some embodiments, communication interfaces 832 and 842 may include or take a variety of forms. In some examples, communication interfaces 832 and 842 may be configured to allow user devices 805 and 806, respectively, to communicate with one or more devices according to a number of protocols described and/or contemplated herein. For instance, communication interfaces 832 and 842 may be configured to allow user devices 805 and 806, respectively, to communicate with the server 801 via the one or more communication networks 808. The hardware processors 834 and 844 may include one or more multi-purpose processors, microprocessors, special purpose processors, digital signal processors (DSP), application specific integrated circuits (ASIC), programmable system-on-chips (SOC), field-programmable gate arrays (FPGA), and/or other types of processing components.

The non-transitory data storages 836 and 846 may include one or more volatile or non-volatile data storages, removable or non-removable data storages, and/or a combination of such data storages that may be integrated in whole or in part with the hardware processors 834 and 844, respectively. Further, data storages 836 and 846 may include non-transitory memories that store instructions and/or instructions sets. Yet further, the hardware processors 834 and 844 may be coupled to the data storages 836 and 846, respectively, and configured to read the instructions from the non-transitory memories to cause the user devices 805 and 806 to perform operations, respectively, such as those described in this disclosure, illustrated by the accompanying figures, and/or otherwise contemplated herein.

In some embodiments, the communication interface 810 is coupled to the one or more processors 802. In some examples, a security module that can take the form of a module in the pattern processing engine 120 of FIGS. 1 and 2 receives a request that includes an authentication request from a client device, e.g., client device 805/806 of a requester through the network interface 810 and a network 808. In response to authenticating the requester, a security key is transmitted through the network interface 810 and the network to the client device 805/806 of the requester. The request is received through the network interface 810 and the network. The pattern processing engine 120 assigns a pattern recognition score and classifies the request and sends, encrypted, the score and the classification through the network interface 810 and the network 808 to the requester. The client device 805/806 of the requester uses the encrypted pattern recognition score and classification to automatically display it.

In some embodiments, the classification of the entity includes assigning the request to an acceptable group if the pattern recognition score is greater than a first predetermined threshold, assigning the request to a failure group if the pattern recognition score is less than a second predetermined threshold, and assigning the request to a limited group if the pattern recognition score is between the first and second thresholds. The assignment of the request to a limited group may include adjusting the limits of the request. In some examples, the request is a transaction request and adjusting may include limiting the amount of the transaction. In some examples, when the request is assigned to the failure group, the adjustment may include ignoring the request.

The present disclosure, the accompanying figures, and the claims are not intended to limit the present disclosure to the example embodiments disclosed. As such, it is contemplated that various alternate embodiments and/or modifications to the embodiment disclosed, whether explicitly described or implied herein, are possible in light of the disclosure and/or the figures. Having thus described embodiments of the present disclosure, persons of ordinary skill in the art will recognize that changes may be made to the embodiments disclosed without departing from the scope of the present disclosure.

What is claimed is:

1. A system, comprising:
a non-transitory memory storing at least a first and a second database; and
one or more hardware processors configured to execute instructions to cause the system to perform operations comprising:
retrieving, from the first database, a first pattern detection model, wherein the first pattern detection model is configured to detect a plurality of first patterns, and wherein the first pattern detection model comprises a plurality of first features for detecting the plurality of first patterns;
retrieving, from the second database, a plurality of second patterns;
selecting, based at least on the plurality of second patterns, a plurality of second features for detecting the plurality of second patterns;
generating a second pattern detection model based at least on the first pattern detection model, wherein the generating comprises:
incorporating one or more of the plurality of second features into the first pattern detection model to create at least a partially trained interim pattern detection model, wherein the second pattern detection model comprises one or more features that do not exist in the first pattern detection model; and
training the partially trained interim pattern detection model using the plurality of second patterns to generate the second pattern detection model;
receiving a request that includes a request pattern;
applying the second pattern detection model to the request pattern to generate a pattern detection score for received request pattern; and
processing the received request based on the pattern detection score.

2. The system of claim 1, wherein the operations further comprises:
receiving the request through a network interface module and a network from a client device of a user;
extracting one or more features of the received request pattern;
generating, based at least on the extracted one or more features and the second pattern detection model, the detection score corresponding to the received request;
classifying, based at least on the detection score, the received request into one of a plurality of groups; and
processing the received request based on the detection score, the classification, or both.

3. The system of claim 2, wherein the client device is a mobile device communicating with the system through a wireless network.

4. The system of claim 2, wherein based at least on the detection score, the received request is classified into a fraudulent request group and the request is not processed.

5. The system of claim 1, wherein the first pattern detection model and the second pattern detection model are models for detecting transaction fraud patterns, and wherein the plurality of first patterns and the plurality of second patterns are transaction patterns.

6. The system of claim 1, wherein generating the second pattern detection model further comprises removing one or more of the plurality of first features.

7. The system of claim 6, wherein a first number of the features of the first pattern detection model and a second number of the features of the second pattern detection model are within five percent of each other.

8. A non-transitory machine-readable medium having stored thereon machine-readable instructions executable to cause a machine to perform operations comprising:
retrieving a first pattern detection model, wherein the first pattern detection model is configured to detect a plurality of first patterns;
retrieving a plurality of second patterns;
generating a second pattern detection model based at least on the first pattern detection model, wherein the generating includes re-training the second pattern detection model using the plurality of second patterns;
receiving a request that includes a request pattern via a network interface module and a network from a client device of a user;
applying the second pattern detection model to the request pattern to generate a pattern detection score for received request pattern; and
processing the received request based on the pattern detection score.

9. The non-transitory machine-readable medium of claim 8, wherein the first pattern detection model comprises a plurality of first features for detecting the plurality of first patterns;
wherein the operations further comprise:
selecting, based at least on the plurality of second patterns, a plurality of second features for detecting the plurality of second patterns; and
wherein the generating further includes:
prior to the re-training, incorporating one or more of the plurality of second features into the first pattern detection model to create a partially trained interim pattern detection model, wherein the second pattern detection model comprises one or more features that does not exist in the first pattern detection model.

10. The non-transitory machine-readable medium of claim 9, wherein the operations further comprise:
extracting one or more features of the received request pattern;
generating, based at least on the extracted one or more features and the second pattern detection model, the detection score corresponding to the received request;
classifying, based at least on the detection score, the received request into one of a plurality of groups; and
processing the received request based on the detection score, the classification, or both.

11. The non-transitory machine-readable medium of claim 8, wherein the client device is a mobile device communicating with the machine through a wireless network.

12. The non-transitory machine-readable medium of claim 8, wherein the operations are performed by a pattern processing engine executing on the machine, and wherein the first pattern detection model and the second pattern detection model are implemented by the pattern processing engine as neural networks.

13. The non-transitory machine-readable medium of claim 8, wherein the first pattern detection model and the second pattern detection model are models for detecting transaction fraud patterns, and wherein the plurality of first patterns and the plurality of second patterns are transaction patterns.

14. The non-transitory machine-readable medium of claim 8, wherein the plurality of first patterns and the plurality of second patterns are patterns of user activities interacting a network-based system.

15. A method of updating a pattern detection model, comprising:
retrieving, by a pattern processing engine executing on a server, a first pattern detection model, wherein the first pattern detection model is configured to detect a plurality of first patterns, and wherein the first pattern detection model comprises a plurality of first features for detecting the plurality of first patterns;
retrieving, by the pattern processing engine, a plurality of second patterns;
selecting, by the pattern processing engine and based at least on the plurality of second patterns, a plurality of second features for detecting the plurality of second patterns;
generating, by the pattern processing engine, a second pattern detection model based at least on the first pattern detection model, wherein the generating includes:
incorporating one or more of the plurality of second features into the first pattern detection model to create a partially trained interim pattern detection model, wherein the second pattern detection model comprises one or more features that does not exist in the first pattern detection model; and
training the partially trained interim pattern detection model using the plurality of second patterns to generate the second pattern detection model.

16. The method of claim 15, further comprising:
receiving, by the pattern processing engine, a request that includes a request pattern through a network interface module and a network from a client device of a user;
extracting, by the pattern processing engine, one or more features of the received request pattern;
applying, by the pattern processing engine and based at least on the extracted one or more features, the second pattern detection model to the request pattern to generate a pattern detection score for received request pattern;
classifying the received request, by the pattern processing engine and based at least on the pattern detection score, into one of a plurality of groups; and
processing, by the pattern processing engine, the received request based on the detection score, the classification, or both.

17. The method of claim 16, wherein the client device is a mobile device communicating with the server through a wireless network.

18. The method of claim 15, wherein the first pattern detection model and the second pattern detection model are models for detecting patterns of activities of users when interacting network-based systems, and wherein the plurality of first patterns and the plurality of second patterns are the patterns of activities of users when interacting network-based systems.

19. The method of claim 15, wherein a first number of the features of the first pattern detection model and a second number of the features of the second pattern detection model are within a predetermined percentage of each other.

20. The method of claim 15, wherein the first pattern detection model and the second pattern detection model are models for detecting patterns of activities occurring inside a systems, and wherein the plurality of first patterns and the plurality of second patterns are the patterns of activities associated with one or more subsystems of the system.
